(19) United States
(12) Patent Application Publication
(10) Pub. No.: US 2015/0379160 A1
(43) Pub. Date: Dec. 31, 2015

(54) APPARATUS AND METHODS FOR TRANSFERRING FOCUS CONTROL AND RELATED RETURN CONTENT WITHIN A GRAPHICAL USER INTERFACE

(71) Applicants: Yaniv AVRAHAM, Qiryat Ono (IL); Guy SHEFFER, Ra'anana (IL); Ran AVIDAN, Zikhron Ya'akov (IL)

(72) Inventors: Yaniv AVRAHAM, Qiryat Ono (IL); Guy SHEFFER, Ra'anana (IL); Ran AVIDAN, Zikhron Ya'akov (IL)

(21) Appl. No.: 14/754,626

(22) Filed: Jun. 29, 2015

Related U.S. Application Data
(60) Provisional application No. 62/018,649, filed on Jun. 29, 2014.

(51) Int. Cl. G06F 17/30; H04L 29/08; G06F 3/0484

(52) U.S. Cl. CPC G06F 17/30991; G06F 3/0484; H04L 67/2842

(57) ABSTRACT

Embodiments of the disclosure herein transform user client device application switching input into instantiated toggling or switching of focus control of a user interface between an application hosting interface elements of return contents associated with the application and the said interface elements. The embodiments include a method comprising the instantiating of a return content in an application for display upon the application next returning to focus control. The method further comprises determining that the application has returned to focus control and displaying a return content only if display criteria associated with displaying the return content have been met.

### CROSS-REFERENCE TO RELATED APPLICATIONS

This application claims benefit of and priority under 35 USC §119 to U.S. Provisional Patent Application Ser. No. 62/018,649 filed Jun. 29, 2014, entitled “APPLICATION FOCUS RETURN AD INJECTION APPARATUSES, METHODS AND SYSTEMS,” the entire contents of which is incorporated by reference herein in its entirety.

This application may contain material that is subject to copyright, mask work, and/or other intellectual property protection. The respective owners of such intellectual property have no objection to the facsimile reproduction of the disclosure by anyone as it appears in published Patent Office file/records, but otherwise reserve all rights.

### FIELD OF THE DISCLOSURE

Some embodiments relate to apparatus and methods used to control the presentation or display at graphical user interface of contents auxiliary to an application. In some instances, the focus control for the graphical user interface toggles between the application and an interface element for the auxiliary contents based on parameters related to a previous appearance of the interface element on the graphical user interface. Further, in some cases, a user affirmatively provides feedback to the auxiliary content to allow the return of the focus control to the application.

### BRIEF DESCRIPTION OF THE DRAWINGS

FIG. 1 shows an example block diagram illustrating aspects of return contents, in one embodiment;

FIG. 2 shows an example data flow illustrating aspects of return contents app pre-loading, in one embodiment;

FIG. 3 shows an example data flow illustrating aspects of displaying contents with return content capabilities, in one embodiment;

FIG. 4 shows an example logic flow illustrating aspects of return content instantiation, in one embodiment;

FIG. 5 shows an example logic flow illustrating aspects of return content conditional display, in one embodiment;

FIG. 6 shows example return content user interfaces, in one embodiment; and

FIG. 7 shows a block diagram illustrating aspects of a client device and a return content server, in one embodiment.

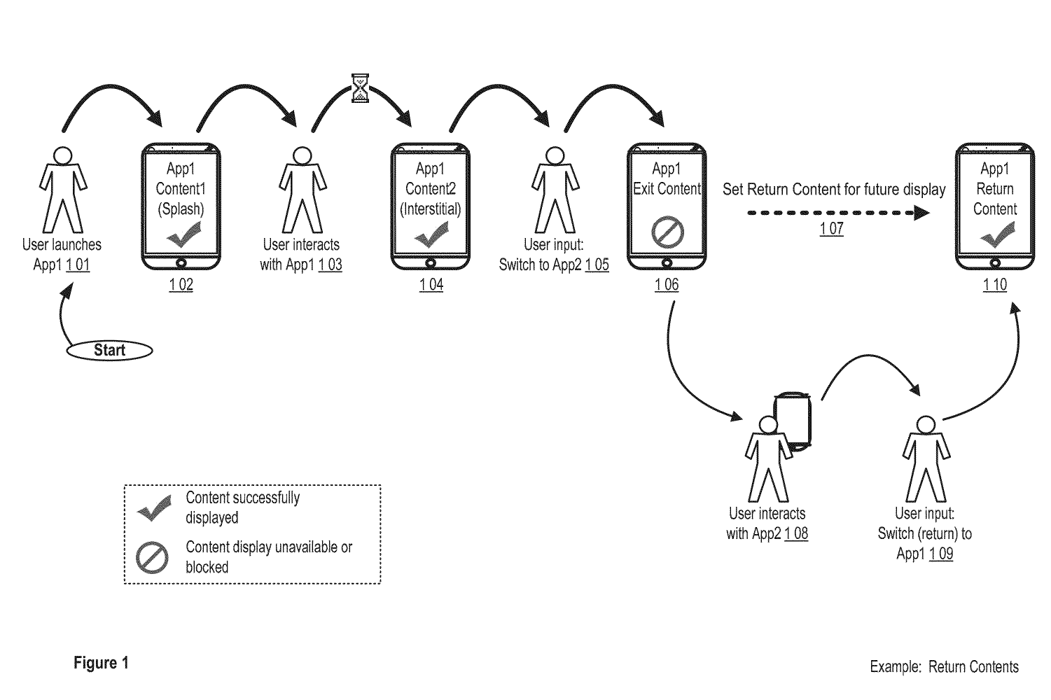

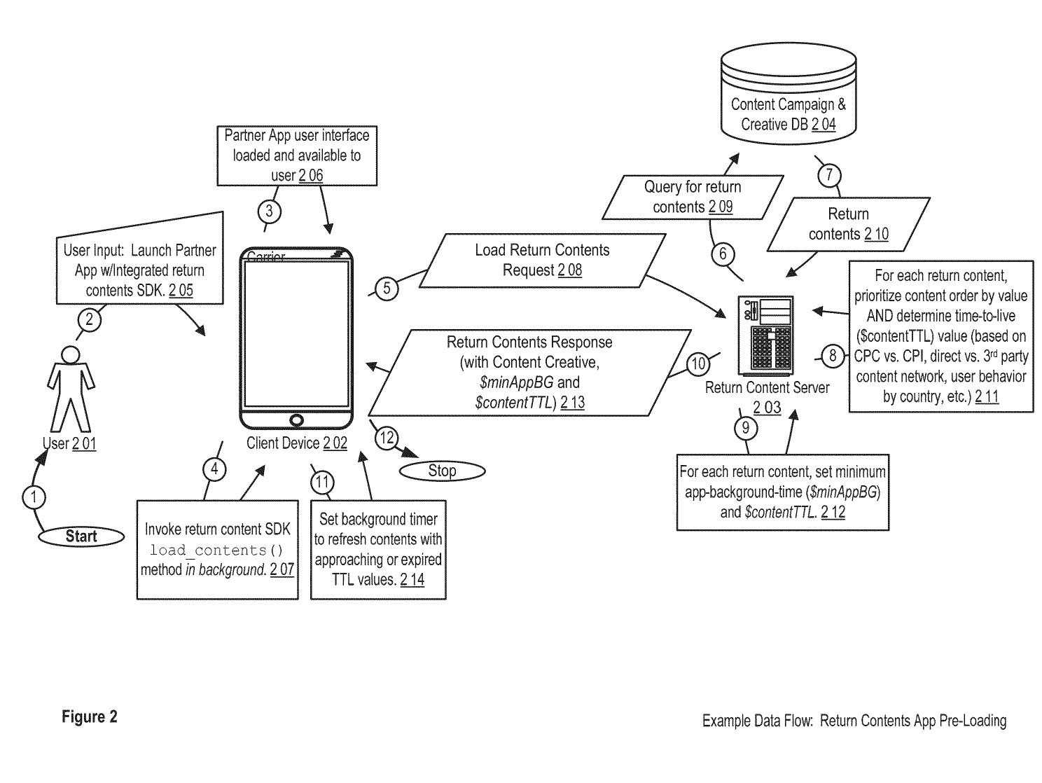

The leading number of each reference number within the drawings indicates the figure in which that reference number is introduced and/or detailed. As such, a detailed discussion of reference number 101 would be found and/or introduced in FIG. 1. Reference number 201 is introduced in FIG. 2, etc.

### DETAILED DESCRIPTION

In some embodiments, the apparatus and methods disclosed herein transform user smart phone application switching input into instantiated return content display triggers and return content impression outputs. In some embodiments, the apparatus and methods disclosed herein can toggle or switch focus control of a user interface (e.g., a touch screen of a smartphone) between two or more interface elements. Considering the case of two interface elements as an example, in some instances, the two or more elements can be two independent applications, while in other instances, one interface element can be an auxiliary element (e.g., announcement) hosted by the other interface element (e.g., an application). In some embodiments, the two or more interface elements can obtain focus control of the user interface (e.g., each may control a portion or an entirety of the user interface, at least substantially simultaneously or alternatively). In some embodiments, focus control of the user interface may reside with a single interface element, and the user interface focus control can toggle or switch amongst the interface elements or the applications. For example, in some instances, a first application may be executing, and the first application may relinquish focus control of the user interface to a second application before end of session of the first application. In such cases, upon the ceding of user interface focus control by the second application, a determination can be made if it is appropriate for the first application to regain focus control of the user interface. For example, the first application may have expired in the time period the focus control resided with the second application, and focus control of the user interface may not be allowed to be transferred to the first application.

In some embodiments, a first application, hosting an interface element for auxiliary contents, may be executing, and focus control of the user interface may be transferred to a second application before end of session of the interface element for auxiliary contents. For example, the interface element may have focus control prior to the transfer, and the transfer may occur before the interface element fully executes (e.g., before the auxiliary contents are fully displayed, etc.). In such cases, upon the second application ceding control of the user interface (to the first application, for example), a determination can be made to allow the return of the interface element of the auxiliary contents to the user interface based on certain conditions that are to be discussed in detail below (e.g., length of time user interface control resided with the second application, etc.), and allow the first application/interface element to regain control of the user interface and to present or display the return contents. Accordingly, focus control transfer to return contents interface element associated with an application can be instantiated upon selection of the first application to focus control of the user interface. In some instances, the transfer to the return contents interface element can be performed substantially instantly upon the selection of the first application to focus control of the user interface. In some embodiments, substantially instantly in this disclosure refers to the time it takes a processor in the smartphone from receiving an indication that a second application is ceding focus control of the user interface to the moment of transfer of the focus control to the return contents interface element by the processor. In some embodiments, this duration may also include some latency inherent in the processing of information by the processor and/or other smartphone components. In some instances, the transfer can occur after a period of time upon the selection of the first application, a period of time that may depend on the user's state. For example, if the user is in motion (e.g., driving), transferring user interface control to the return contents interface element can be delayed for a variety of reasons (e.g., safety, to increase the chance the user indeed pays attention to the return contents, etc.) until it is determined the user has ceased moving. In some instances, the period of time can depend on input from the user, the application and/or other applications (e.g., a motion detector app in the smartphone).

FIG. 1 shows an example block diagram illustrating aspects of return contents, in one embodiment. In one embodiment, a user may launch an application, here App1, on their smart phone, e.g., 101. The developer of the application may have integrated a software developer kit (SDK) into the application source code for implementing embodiments of the instant disclosure. As such, when the user launches the application the smart phone can also load into memory and execute stored program commands corresponding to some or all of the SDK operations. In so doing, the SDK may interface with a return content server via an application program interface (API).

In one embodiment, the application executing on the user's smart phone can display contents at various points of the user's interaction with the application's user interface. For example, upon the initial loading of the application, the user interface can display contents such as but not limited to an interstitial announcement or display (e.g., a splash announcement or advertisement) to the user, e.g., 102. Thereafter, upon a time period elapsing, at a predetermined or random point in the user's application interaction, after a fixed number of user interaction events (e.g., clicks, swipes, etc.) and/or the like, the user interface can display an interstitial content to the user, e.g., 104. An interstitial content is a content inserted into the normal user interface flow of an application and is often a full-screen content that the user must affirmatively dismiss.

As shown in FIG. 1, at some point during the user's interaction with the running App1, the user may desire to switch to another application or exercise another capability of the smart phone, e.g., 105. For example, the user can provide input to return to the smart phone's “home screen,” switch to another application installed on the smart phone, use an integrated web browser to view a link provided by App1, place an outgoing or accept an incoming phone call, and/or the like. In other embodiments, the smart phone operating system may itself grab focus control from the currently running App1 and delegate the focus control to a native operating system function or another smart phone application. For example, in the case of an incoming call, the smart phone can automatically defocus or otherwise leave App1 and launch a “phone” application on the smart phone. The user can then be prompted by the phone application to answer the incoming call. Under these circumstances, the previously running application (e.g., App1) state can still be retained in memory of the phone such that the user can later continue interacting with App1 from substantially the same place of interruption or exit. Although discussed below with respect to a defocus of App1 caused by a user input to switch to another smart phone application (e.g., user input to switch from App1 to App2), it is to be understood that the embodiments described herein are equally applicable to other control flows such as those described above. Therefore, regardless of the mechanism or manner in which a running application loses focus control, the disclosed embodiments disclosed may be configured to provide the return content capabilities described herein.

In one embodiment, the smart phone user can provide input sufficient to instruct the operating system to switch or transfer control of some or all of the device user experience from a first application to a second application. Here, the user input indicates a transfer of focus control from App1 to App2, e.g., 105. Prior to relinquishing focus, App1 may display exit content (e.g., announcement) to the user via the user interface. An exit content is a content shown to the user whenever focus control is about to be removed from the application.

In some smart phone environments, the user input to switch applications, e.g., 105, can immediately remove the previous application from active execution. As such, in at least these situations, App1 running on the smart phone can be prevented from providing exit content 106 prior to losing control of the user experience. In other words, the display of an exit content may be blocked because the supervising operating system immediately removes control from the running application upon receipt of the user input.

In the case where an exit content was blocked from display, a trigger can be set to display a return content once the application again has focus control, e.g., 107. In one embodiment, after transferring to and interacting with another application or smart phone function, e.g., 108, the user can provide input to the smart phone to switch or return focus to the previously-running application, e.g., 109. If the smart phone application has been configured to display a return content upon returning to focus, a return content is displayed, e.g., 110.

It should be appreciated that the return content display or provision configuration described above is just one example return contents configuration. As such, the embodiments of the disclosure herein are not limited to displaying return contents only when an exit content fails to display. Alternative configurations can cause return contents to display every time an application returns to focus control. In such a configuration, the return contents functions in a capacity similar to an initial content display (e.g., splash contents), only the return contents would be shown every time the user returned to a previous application session and not only on the initial application launch. In still other embodiments, the return contents may be triggered whenever the application loses focus control for more than a specified amount of time. In such a configuration, briefly switching focus control to a messaging application to reply to an incoming message before returning to the previously active application would not cause a return content to display. Longer periods of application defocus, however, would trigger a return content display.

FIG. 2 shows an example data flow illustrating aspects of return contents app pre-loading, in some embodiments. In one embodiment, a user 201 may provide a user input to client device 202 instructing the client device to launch an application with the return content SDK integrated, e.g., 205. The application can thereafter be launched by the client device and the user interface may render the application for user interaction, e.g., 206. In many cases, user 201 can be unaware of the presence of the SDK, as the application being launched may function in a manner similar to an application lacking the return content capabilities.

After the application is loaded, the application code may interact with the integrated SDK functions to invoke a load_contents ( ) method, e.g., 207, which may then proceed to pre-load return contents in the background for later use and display. In one embodiment, the client device can initiate a request to load return contents from a return content server 203, e.g., load return contents request 208.

In some instances, the return content server 203 can receive the return contents request and thereafter initiate a query 209 to a contents delivery campaign (e.g., a series of messages that share a single idea or theme over a specific time period; an advertising campaign, etc.) and creative database 204. In response, the contents delivery campaign and creative database 204 can provide records 210 corresponding to content creative configured for return content display as well as campaign data for the contents delivery campaign to which the content creative belongs. In other embodiments, the load_contents ( ) procedure may involve multiple rounds of client side or server side analysis, optimizations, and/or filtering. Examples of such operations are provided throughout this disclosure.

The retrieved data can then be further processed by the return content server to optimize or improve the return contents records provided in response to the return contents request 208, e.g., 211. In one embodiment, the return contents provided by the contents delivery campaign and creative database 204 can be prioritized based on the likely or calculated value of the content. The value associated with the content can be, for example, the amount of money a content provider (e.g., an entity funding the content delivery campaign, an advertiser, etc.) is willing to pay for a content impression. Other content value determinations can be based partially or completely on, for example, the probability that a given content will be relevant to a user (for example, based on the user's response to previous return contents), whether the creative used for the return content has been seen by the client device user via a different content delivery vehicle (e.g., splash content, interstitial content, etc.), the number of impressions contracted for by a content provider, the content delivery campaign's delivery window time remaining, and/or the like.

In addition to prioritizing return contents by value, the return content records can also be ranked based on a time-to-live (TTL) value associated with the content. A TTL corresponds to the amount of time a content creative will be available for display on a user device. Once the TTL for a given return content has expired, another content with a still active TTL can be displayed as the return content or another load return contents request can be initiated, e.g., 208, to retrieve updated creative. In some instances, a TTL value can be determined for a given creative based on factors such as whether the underlying content is contracted for by the content provider on a cost-per-click (CPC), cost-per-install (CPI) or cost-per-impression (CPM) basis. For example, content that is sold as CPC is often concerned with ultimate user response (e.g., getting the user to click on the content) and therefore can have relaxed display timing requirements allowing a longer TTL value for the ad. In contrast, creative that is sold as CPM may be part of an event branding campaign (e.g., concerned with maximizing views of the content within a certain time window) and as such may have smaller TTL values to ensure contents are not displayed past the branding campaign end time. Contents that are sold as CPI are usually concerned with building an installed user base and so therefore may have relaxed TTL values similar to CPC TTL values described above. Because TTL values are used to determine whether to display contents in essentially an “off line” mode of operation (e.g., where real-time access to the return content server 203 may be unavailable or inconsistent with content display decision latency needs), the optimization of the return content TTL value can allow for proper or desired return content delivery platform configuration even when the client device 202 is not receiving updated information from the return contents SDK. In other embodiments, the TTL value for a return content creative can be optimized based on other factors such as whether the content delivery campaign is a direct campaign managed at the client device level (e.g., pre-loaded campaign) or a campaign managed by a third-party network, based on prior or predicted user behavior (such as predicted user behavior by country, etc.), and/or the like. For example, third-party content delivery campaigns may be subject to frequent changes and otherwise be out of the direct control of, for example, a return content server administrator. Therefore, shorter TTL values can be assigned to such creative return content units to minimize the display of return contents that are unlikely to be paid for by the third-party content network because the campaign for the particular content is no longer funded or active.

In addition to having a content specific TTL value calculated, the return content server 203 can have a minimum application background time value set, e.g., 212. The minimum application background time value corresponds to the amount of time an application employing return contents should be out-of-focus before a return content is displayed upon application regaining focus control. The minimum application background time value allows for the suppression of return contents in cases where the user only briefly leaves the active application and would find the display of a return content to be potentially bothersome (such as when leaving an application briefly to reply to a received email).

The return content server 203 can respond to smart phone 202 with the determined return contents for precaching, e.g., return contents response 213.

In some instances, the return contents can be pre-filtered as described herein such that no further processing or selection logic need be employed by the user device. In other embodiments, the smart phone running the return contents SDK can further process or filter the return contents response. Upon receipt of the return contents response, smart phone 202 may set a local trigger (e.g., a cron job, and/or the like) to refresh return content creative that has an approaching or expired TTL value, e.g., 214.

In some of these instances, the return contents associated with an application can be retrieved from a pre-load return content cache. For example, upon selection of the application to regain control of a user interface from a second application (for example, after relinquishing or ceding control to the second application during a previous session), a determination can be made that control of the user interface should be transferred, substantially instantly or after a delay of time, to the interface element associated with the return contents, and these return contents may be retrieved from a pre-load cache. In some embodiments, prior to the retrieval, the return contents can be cached in the pre-load return content cache based on return-contents focus-control-transfer prioritization criteria. These criteria can be used to set the order in which the return contents that at least substantially satisfy focus control transfer criteria can be provisioned at the user interface. In some embodiments, focus control transfer priority rankings for the retrieved return contents can be evaluated based on the return-contents focus-control-transfer prioritization criteria, and the transfer of focus control can be set (or defined) according to the priority rankings.

In some embodiments, “substantially satisfying the criteria” can be interpreted as meeting the criteria within some range of a quantifiable quantity used to characterize the criteria. For example, if the focus control transfer criteria is some threshold time-to-live value for the return contents, then time-to-live values within some range (e.g., from about 90% of the threshold time-to-live value to about 100%) can be considered to substantially satisfy the criteria. As another example, if the focus control transfer criteria is some threshold minimum time value for the application to be out of focus before focus control is transferred to the return content interface element, then time durations during which the application is out of focus and are within some range (e.g., from about 90% of the threshold minimum time value to about 110%) can be considered to substantially satisfy the criteria.

Examples of the return-contents focus-control-transfer prioritization criteria include relevance measures of each of the return contents to a user of the application and/or the return contents. These measures can be determined at the client device and/or be provided by the content provider (e.g., content delivery campaign owner). For example, the monetary values associated with each return content as discussed above can be considered in determining the priority rankings. In some embodiments, the return-contents focus-control-transfer prioritization criteria can include the determination of whether the return contents have been presented or been available to the user previously. That is, in determining whether to transfer user interface control from an application to a return content interface element, the criteria of whether the return contents have been presented or displayed in a previous session of the application or in another platform altogether can be used. In some instances, the criteria may include the determination of whether the return contents have assumed user interface control in a previous session of the application prior to relinquishing control to another application. Other examples of return-contents focus-control-transfer prioritization criteria include one or more time-to-live values for the return contents, and number of return contents provision count remaining before expiration of the return contents (e.g., if the content provider has mandated a certain count for the number of return content display or provision). In some embodiments, the compliance of the return contents to the return-contents focus-control-transfer prioritization criteria can be monitored (e.g., regularly, continually, etc.) until user interface control is transferred to return contents interface elements. For example, a time-to-live value of each of the retrieved return contents can be monitored until focus control of the user interface is transferred to the one or more of the return contents substantially satisfying the focus control transfer criteria. As discussed above, examples of the focus control transfer criteria include a time-to-live value(s) for the return contents, a minimum time the application hosting the interface element for the return contents is out-of-focus before focus control is transferred to the interface element, and/or the like.

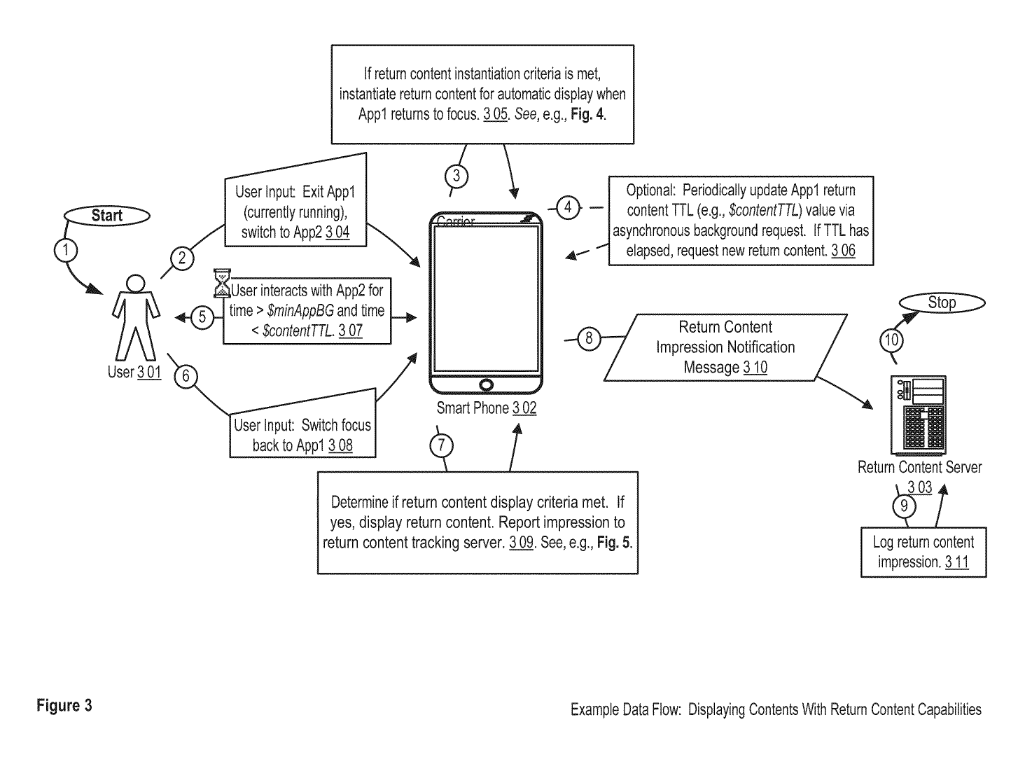

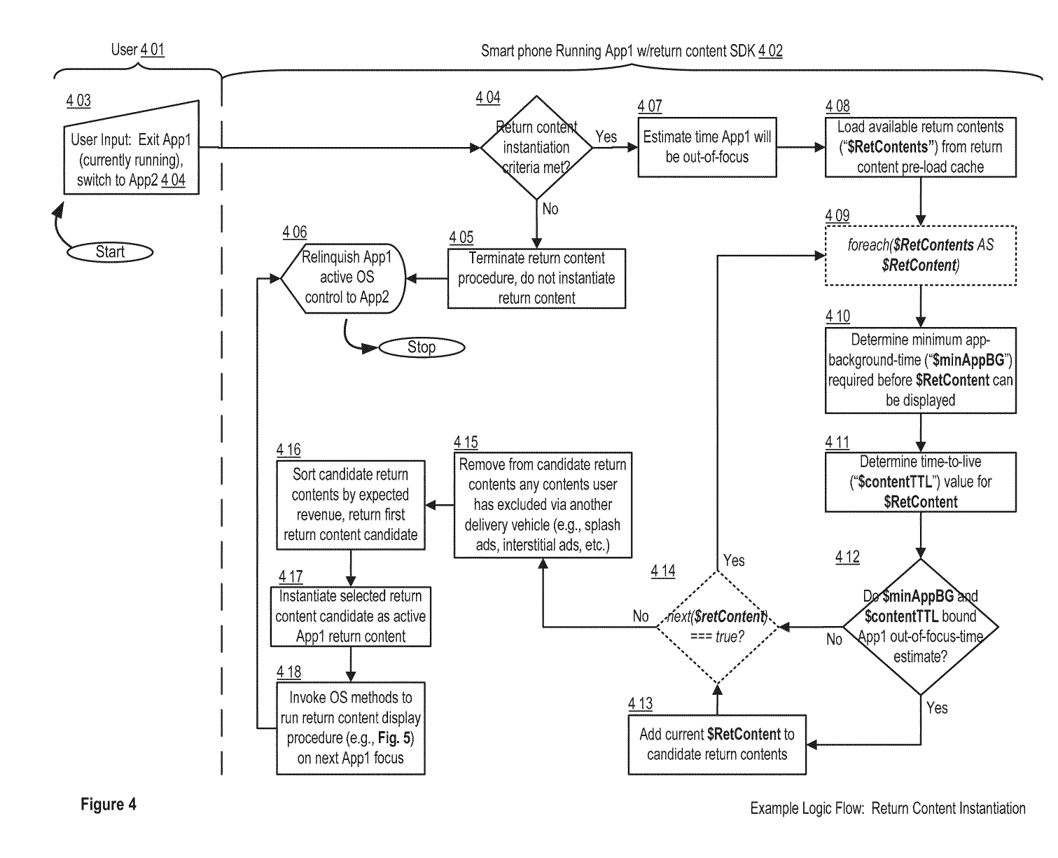

FIG. 3 shows an example data flow illustrating aspects of displaying contents with return content capabilities, in one embodiment. User 301 may provide an input, such as a tap, double-tap, swipe, click, audio command, and/or the like, to client device 302. The user input can instruct the client device operating system to transfer control from a currently running application App1 to another application App2, e.g., 304. If the criteria used for return content instantiation is met (e.g., criteria to set a trigger such that a return content can be conditionally displayed upon App1 losing and then returning to focus), a return content trigger can be set on the client device, e.g., 305. Further detail with respect to return content instantiation can be found herein and particularly with respect to FIG. 4.

As shown in FIG. 3, the client device can also instantiate a trigger to periodically update the time-to-live (TTL) value associated with a return content via an asynchronous background request, e.g., 306. The asynchronous background request can be used to monitor the TTL for a given return content creative and update the creative TTL in real-time. The reasons for TTL variability as well as example conditions impacting the determination of return content TTL values can be found herein and particularly with respect to FIG. 2. In one embodiment, if the TTL for the currently-instantiated return content has elapsed, the client device can request a replacement return content via the asynchronous request update if there are no other suitable return content candidates available in the client device return content cache previously populated during the return content pre-loading procedure execution.

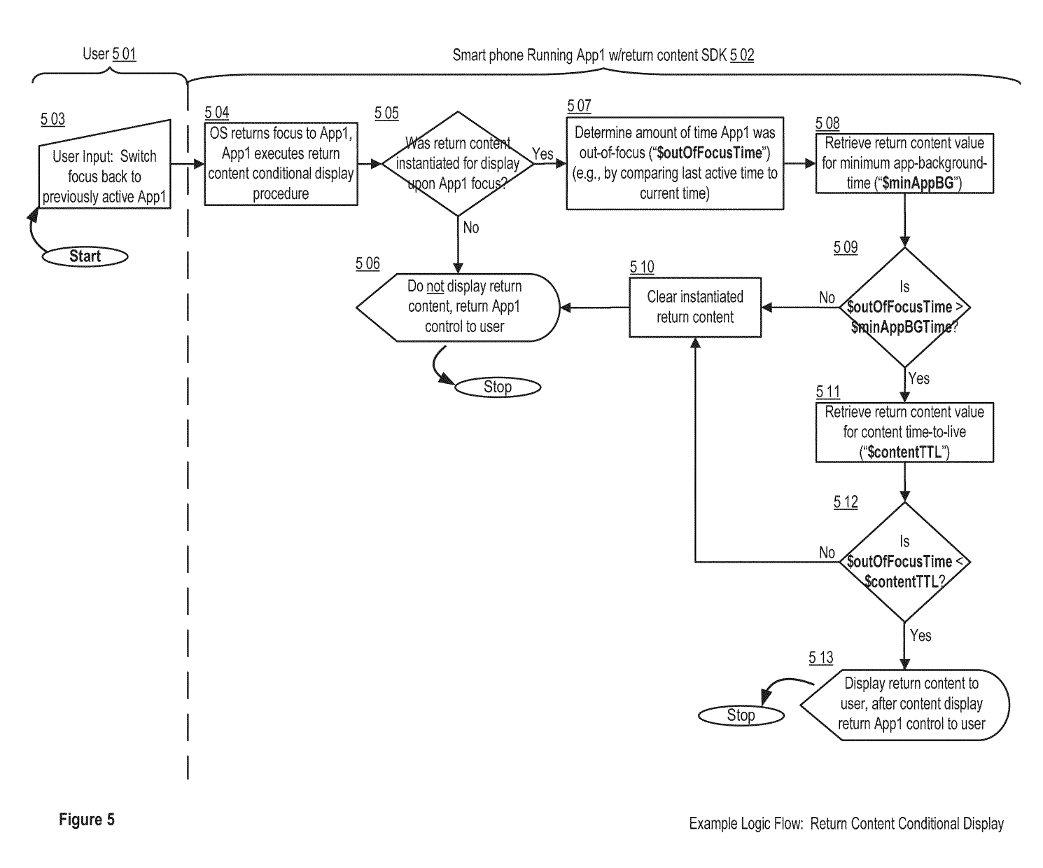

Once App1 has been removed from focus control and replaced by App2, user 301 can interact with App2 in the normal manner, e.g., 307. After a time period greater than the minimum application background time value and less than the TTL associated with the return content, user 301 can provide client device 302 with input requesting a transfer of focus control from the active App2 back to the previously active App1, e.g., 308. Upon returning to focus, the client device can immediately determine if the criteria to display a previously-instantiated return content candidate has been met, e.g., 309. For example, the client device can determine if the time App1 was out-of-focus was within the time bounded by the values by the minimum application background time and the return content TTL. If the return content display criteria have been met, the return content can be displayed at the user interface and the client device can report the impression to a tracking server such as the return content server 303. Further detail regarding return content conditional display can be found herein and particularly with respect to FIG. 5.

In other embodiments, App1 can display the return content after a delay. The delay can be variable by application. For example, if the user is returning to a navigation app, the return content can be temporarily suppressed until the app determines that the user is not in motion (e.g., delay the display of a return content until it is safer to do so). In still other embodiments, the return contents can be displayed based on the priority of App1 relative to other applications installed on the smart phone. In some embodiments, the display of exit contents may occur only when the user exits or returns to App1 a certain number of times. For example, a return content may be displayed every third time the user returns to App1.

As shown in FIG. 3, client device 302 can then generate a message notifying return content server 303 of the successful return content display, e.g., return content impression notification message 310, which can be recorded by the content server and used to update the campaign records associated with the return content, e.g., 311.

FIG. 4 shows an example logic flow illustrating aspects of return content instantiation, in one embodiment. As shown in FIG. 4, user 401 can provide an input to client device 402 indicating that the smart phone operating system should transfer focus from currently active App1 (e.g., user interface control, smart phone resource access, and/or the like) to App2, e.g., 403. The client device can be configured with return content SDK capabilities described herein and therefore can also have access to any of capabilities of the embodiments of the disclosure disclosed herein (either locally or via network access).

The client device can determine if criteria for the instantiation of return contents have been met, e.g., 404. Return content instantiation criteria can include, for example, whether an exit content has been shown to the user prior to application defocus, the number of user interface interactions with App1, and/or the like. If the return content instantiation criteria are not met, the procedure may then terminate without setting a return content trigger, e.g., 405. The smart phone can then transfer focus control from the previously active App1 to the user input specified App2, e.g., 406.

If the criteria for return content instantiation have been met, e.g., 404, the smart phone can estimate the amount of time that App1 may be out of focus control, e.g., 407. Such an estimate can be based on, for example, the average historical time App1 is usually out-of-focus when transferring control to another user space application. Thereafter, the smart phone can query a local return content pre-load cache to determine available return contents for instantiation, e.g., 408. The cache can be one created or produced during the execution of a procedure to pre-load return contents as described herein and particularly with respect to FIG. 2. In other embodiments, the smart phone can dynamically load return contents (or only one return content) from a return content Server.

For each available return content, e.g., 409, the client device can determine the minimum application background time value associated with the content, e.g., 410. In some embodiments, the time value can be associated with all return contents (e.g., a default or single time value) while in other cases the minimum application background time value can be specified on a per-return-content level. The client device may then determine the TTL value associated with the current return content, e.g., 411.

If the application out-of-focus estimate previously determined above is lower bounded by the minimum application background time value and upper bounded by the return content TTL value, e.g., 412, then the current return content is added to a list of candidate return contents for instantiation, e.g., 413. The procedure can repeat for all available return contents, e.g., 414.

As shown in FIG. 4, the candidate return content list can be scanned to remove any return contents that should be excluded from display (or ranked lower in the priority rankings for display, in some embodiments) because they have been previously shown to the user via another content creative delivery channel (for example, another channel such as one described above with respect to FIG. 1), e.g., 415. In some embodiments, the candidate return contents are then sorted by expected revenue upon successful display, e.g., 416. In yet some embodiments, the candidate return contents can be sorted by return-contents focus-control-transfer prioritization criteria discussed above. The top candidate return content is then selected and instantiated, e.g., 417. Underlying operating system methods on the client device are then called by the SDK to set a trigger for the execution of a return content conditional display procedure upon App1 returning to focus control, e.g., 418.

Although the determination of candidate return contents has been shown here to be performed at the client device (e.g., smart phone based return content determinations), it should be appreciated that such filtering and/or determinations can also take place either via communication with or completely by another entity. For example, return content server 203 may itself perform some or all of the filtering functions described above before providing return contents response 213.

FIG. 5 shows an example logic flow illustrating aspects of return content conditional display, in one embodiment. As shown in FIG. 5, user 501 can provide an input to client device 502 instructing the operating system to switch from focused application App2 back to previously active App1, e.g., 503. The client device operating system can then return focus control to App1 and automatically execute a return content conditional display procedure, e.g., 504. If a return content was not instantiated for display upon App1's return to focus, e.g., 505, then no return content may be displayed and control of user interface can be returned to App1/the user, e.g., 506. If, however, a return content was instantiated for conditional display, the client device can determine how long App1 was out-of-focus, e.g., 507. For example, the client device can subtract the current system time from the last time recorded in App1's application execution log to determine how long the application was out-of-focus.

Accordingly, the minimum application background time value associated with the instantiated return content can be determined, e.g., 506, as well as whether that value is greater than the out-of-focus time for App1 calculated above, e.g., 509. By so doing, App1 can suppress the display of return contents when the user briefly exits the application. In such a case, the client device may clear the instantiated (but not displayed) return content, e.g., 510, and return control of App1 to the user, e.g., 506.

Thereafter, the return contents SDK running on the client device can determine the time-to-live (TTL) value associated with the return content, e.g., 511, and verify that App1's out-of-focus time was less than the value, e.g., 512. In so doing, the display of “stale” or no longer valid return contents is suppressed. Should the return contents SDK running on the client device determine that the TTL for a return content has expired, another return content with a still-active TTL may be chosen. In another embodiment, a request can be initiated to a return content server to request additional return contents in real-time. In the case where the earlier instantiated return content's TTL is still valid, however, the client device may thereafter render the return content and then return control of App1 back to the user, e.g., 513.

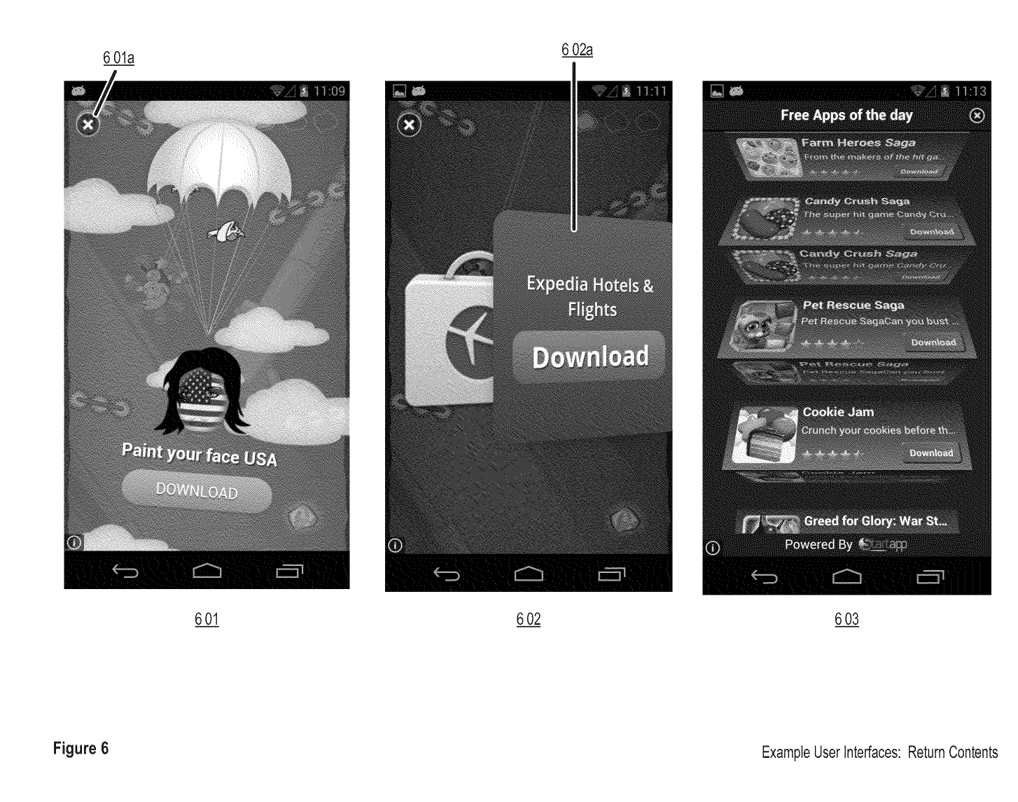

FIG. 6 shows example return content interface elements, in one embodiment. Return content interface elements can take many forms including full-screen static or animated announcements (e.g., product announcements, advertisements, etc.), interactive contents such as those with integrated capabilities for user purchases or third-party application instant downloads, contents to push or pull coupons to the user via the return contents or another delivery channel, and/or the like, e.g., 601-603. In one embodiment, a user who has been shown a return content, e.g., 601, may click an “X” 601a to dismiss the content and return focus control to the context of the underlying app (e.g., the app that launched the return content interface element). In another embodiment, a user who has been shown a return content, e.g., 602, may click the content in the interface element and be redirected to a target location such as a landing page, marketplace, and/or the like, e.g., 602a. In some embodiments, the target location may be removed or different from the hosting or underlying application. For example, it may be a different application hosting one or more interface elements for the return contents, e.g., 603. In some instances, it may be a webpage, a video or audio destination, and/or the like.

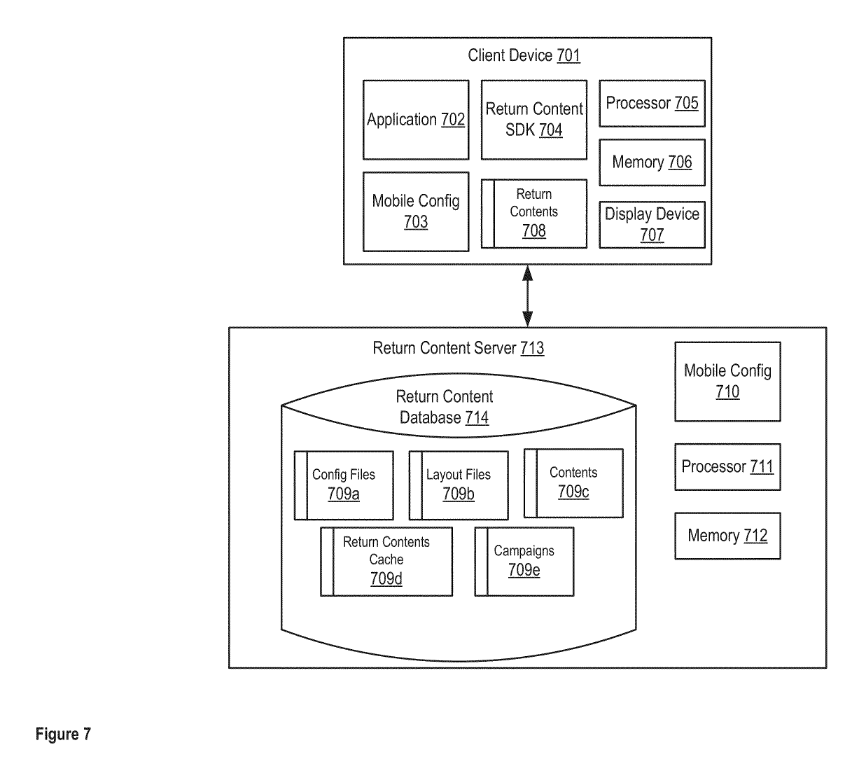

FIG. 7 is a schematic diagram illustrating a client device 701 and a return content server 707. For example, in some implementations, a client device 701 can be a physical hardware device including at least one memory 706, at least one processor 705, and at least one display device 707 (e.g., a liquid-crystal (LCD) display screen, and/or a similar display device). The client device 701 can be a personal computer (e.g., a laptop, and/or a like personal computing device), a mobile device (e.g., a smartphone and/or similar mobile phone device (e.g., running an Operating System such as, but not limited to, iOS, Android, Windows Phone 8, Blackberry OS, and/or similar Operating Systems), a tablet, a phablet, a personal digital assistant (PDA), wearable devices (e.g., smart watches, augmented reality vision devices, and/or similar devices), and/or a similar mobile device), and/or a similar device. The client device 701 can install applications 702, e.g., from a vendor and/or a similar developer. The client device 701 can also store mobile configuration files 703, a return content SDK 704 and return contents 708. Although not explicitly shown in FIG. 7, applications 702, mobile configuration files 703, return content SDK 704 and return contents 708 can be stored within memory 706, and implemented and/or executed by processor 705.

The mobile application 702 can interact with the mobile configuration file 703 and the return content SDK 704 to determine how to organize data within the mobile application 702 and/or to determine particular features to include within the mobile application 108. For example, the mobile configuration file 703 can contain layout information (e.g., color information, font family and font size information, and/or similar information), and/or can contain feature flags corresponding to particular features (e.g., a shopping cart, a search feature, interface element for a return content and/or similar features) that the mobile application may implement. The mobile configuration file can also be referred to as a mobile application configuration data structure and/or a mobile application configuration file. The mobile configuration file can be platform-agnostic (e.g., the mobile configuration can be used by applications running on multiple mobile platforms, and may not require translation between mobile platforms).

In some embodiments, the applications 702 can host return content interface elements. As discussed above, the application 702 can also use the SDK 704 in conjunction with the mobile configuration file 703 to determine how to render and/or otherwise implement interface elements for return contents as well as application layout and other features within the application 702. The SDK 704 can include information on how to implement features for each particular operating system and/or mobile platform, how to implement features specified in the mobile configuration file 703, and/or other information related to the interface elements for the return contents. In some implementations, for example, the application 702 can use the SDK 704 to define a nested tree data structure from the mobile configuration file 703, such that the application 702 can determine more quickly how particular components of the return content interface elements layout should be rendered. The application 702 can then traverse the nested tree when the application 702 is rendering a particular return content interface element, for example.

The return content server 713 can be implemented as a single server or a cluster of servers hosting a cloud data storage network. The return content server 713 can include at least one processor 711, at least one memory 712, and at least one return contents database 714. Although not explicitly shown in FIG. 7, return contents database 714 can be stored within memory 712 or can be located within a device separate from and accessible by return content server 713.

The return contents database 714 can include records for mobile configuration file records 709a, layout data structure records 709b, contents 709c, return contents cache 709d, campaigns 709e, and/or the like. The mobile configuration files records 709a can include records of past and/or recent mobile configuration files. The layout file records 709b can include records of layouts included in a mobile configuration file. The contents 709c can include contents provided by content provider for provision to the user via the application 702. The return contents cache 709d can include cache for return contents to which focus control of the user interface may be transferred to upon selection of the application to focus control of the user interface. The campaigns 709e can include a set of contents, rules/preferences for presenting the contents, etc., that are provided by content providers to the return content server and/or client device for delivery by the client device to the user of the device.

While various embodiments have been described and illustrated herein, a variety of other means and/or structures for performing the function and/or obtaining the results and/or one or more of the advantages described herein, and each of such variations and/or modifications is deemed to be within the scope of the disclosure. More generally, all parameters, dimensions, materials, and configurations described herein are meant to be examples and that the actual parameters, dimensions, materials, and/or configurations will depend upon the specific application or applications. It is, therefore, to be understood that the foregoing embodiments are presented by way of example only.

The above-described embodiments can be implemented in any of numerous ways. For example, embodiments of designing and making the mobile configuration files, mobile application layouts, interface elements for return contents, etc., disclosed herein may be implemented using hardware, software or a combination thereof. When implemented in software, the software code can be executed on any suitable processor or collection of processors, whether provided in a single computer or distributed among multiple computers.

Further, it should be appreciated that a computer may be embodied in any of a number of forms, such as a rack-mounted computer, a desktop computer, a laptop computer, or a tablet computer. Additionally, a computer may be embedded in a device not generally regarded as a computer but with suitable processing capabilities, including a Personal Digital Assistant (PDA), a smart phone or any other suitable portable or fixed electronic device.

Also, a computer may have one or more input and output devices. These devices can be used, among other things, to present a user interface. Examples of output devices that can be used to provide a user interface include printers or display screens for visual presentation of output and speakers or other sound generating devices for audible presentation of output. Examples of input devices that can be used for a user interface include keyboards, and pointing devices, such as mice, touch pads, and digitizing tablets. As another example, a computer may receive input information through speech recognition or in other audible format.

Although not explicitly shown in FIG. 7, computers such as the client device 701 and servers such as the return content server 713 may be interconnected by one or more networks in any suitable form, including a local area network or a wide area network, such as an enterprise network, and intelligent network (IN) or the Internet. Such networks may be based on any suitable technology and may operate according to any suitable protocol and may include wireless networks, wired networks or fiber optic networks.

The various methods or processes (e.g., of designing and making the mobile configuration files, transferring focus control, mobile application layouts disclosed above) outlined herein may be coded as software that is executable on one or more processors that employ any one of a variety of operating systems or platforms. For example, some or all of the components of the system illustrated by the schematic diagram FIG. 7 (whether explicitly shown in FIG. 7 or not) can be used to implement the methods and processes disclosed herein (such as the method of toggling focus control to transfer focus control of user interfaces between applications, interface elements for return contents, etc.). Additionally, such software may be written using any of a number of suitable programming languages and/or programming or scripting tools, and also may be compiled as executable machine language code or intermediate code that is executed on a framework or virtual machine.

In this respect, various inventive concepts may be embodied as a computer readable storage medium (or multiple computer readable storage media) (e.g., a computer memory, one or more floppy discs, compact discs, optical discs, magnetic tapes, flash memories, circuit configurations in Field Programmable Gate Arrays or other semiconductor devices, or other non-transitory medium or tangible computer storage medium) encoded with one or more programs that, when executed on one or more computers or other processors, perform methods that implement the various embodiments of the invention discussed above. The computer readable medium or media can be transportable, such that the program or programs stored thereon can be loaded onto one or more different computers or other processors to implement various aspects of the disclosure discussed above.

The terms “program” or “software” are used herein in a generic sense to refer to any type of computer code or set of computer-executable instructions that can be employed to program a computer or other processor to implement various aspects of embodiments as discussed above. Additionally, it should be appreciated that according to one aspect, one or more computer programs that when executed perform methods described herein need not reside on a single computer or processor, but may be distributed in a modular fashion amongst a number of different computers or processors to implement various aspects of the present invention.

Computer-executable instructions may be in many forms, such as program modules, executed by one or more computers or other devices. Generally, program modules include routines, programs, objects, components, data structures, etc. that perform particular tasks or implement particular abstract data types. Typically the functionality of the program modules may be combined or distributed as desired in various embodiments.

Also, data structures may be stored in computer-readable media in any suitable form. For simplicity of illustration, data structures may be shown to have fields that are related through location in the data structure. Such relationships may likewise be achieved by assigning storage for the fields with locations in a computer-readable medium that convey relationship between the fields. However, any suitable mechanism may be used to establish a relationship between information in fields of a data structure, including through the use of pointers, tags or other mechanisms that establish relationship between data elements.

Also, various aspects of the description discussed herein may be embodied as one or more methods, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

What is claimed is:

1. A processor-implemented control toggling method, comprising:
instantiating focus control transfer to interface elements of return contents associated with an application upon selection of the application to focus control of a user interface;
retrieving the return contents associated with the application from a pre-load return content cache upon determination of the selection of the application; and
transferring focus control of the user interface to one or more of the interface elements of the return contents substantially satisfying focus control transfer criteria associated with each of the retrieved return contents.

2. The method of claim 1, wherein the selection of the application to focus control of the user interface takes place after the application cedes focus control of the user interface at a previous session of the application.

3. The method of claim 1, wherein the retrieved return contents are cached in the pre-load return content cache based on return-contents focus-control-transfer prioritization criteria prior to retrieval.

4. The method of claim 1, wherein the transferring of focus control is performed substantially instantly upon the selection of the application to focus control of the user interface.

5. The method of claim 1, wherein the transferring of focus control is performed after a period of time upon the selection of the application to focus control of the user interface.

6. The method of claim 1, wherein:
the transferring of focus control is performed after a period of time upon the selection of the application to focus control of the user interface, and
the period of time depends on input from the application and/or other applications.

7. The method of claim 1, wherein:
the transferring of focus control is performed after a period of time upon the selection of the application to focus control of the user interface,
the period of time depends on input from the application and/or other applications, and
the input indicates state of motion of a user of the application and/or a device upon which the application executes.

8. The method of claim 1, further comprising:
determining focus control transfer priority rankings for the cached and/or the retrieved return contents based on return-contents focus-control-transfer prioritization criteria.

9. The method of claim 1, further comprising:
determining focus control transfer priority rankings for the cached and/or the retrieved return contents based on return-contents focus-control-transfer prioritization criteria, wherein the transferring of focus control is performed according to the priority rankings.

10. The method of claim 1, wherein the focus control transfer criteria include a time-to-live value for the return contents.

11. The method of claim 1, wherein the focus control transfer criteria include a minimum time the application is out-of-focus before focus control is transferred to one or more of the interface elements of the return contents.

12. The method of claim 1, wherein:
the retrieved return contents are cached in the pre-load return content cache based on return-contents focus-control-transfer prioritization criteria prior to retrieval, and
the return-contents focus-control-transfer prioritization criteria include relevance measures of each of the return contents to a user of at least one of the application and the return contents.

13. The method of claim 1, wherein:
the retrieved return contents are cached in the pre-load return content cache based on return-contents focus-control-transfer prioritization criteria prior to retrieval, and
the return-contents focus-control-transfer prioritization criteria include at least one of (1) provision of the return contents prior to the selection of the application, and (2) control of the user interface by interface elements of the return contents prior to the selection of the application.

14. The method of claim 1, wherein:
the retrieved return contents are cached in the pre-load return content cache based on return-contents focus-control-transfer prioritization criteria prior to retrieval, and
the return-contents focus-control-transfer prioritization criteria include at least one of (1) time-to-live value for the return contents and (2) number of return contents provision count remaining, before expiration of the return contents.

15. The method of claim 1, further comprising:
monitoring time-to-live value of each of the retrieved return contents until focus control of the user interface is transferred to the one or more of interface elements of the return contents substantially satisfying the focus control transfer criteria.

16. A processor-implemented control toggling system, comprising:
a memory;
a processor disposed in communication with said memory, and configured to issue a plurality of processing instructions stored in the memory, the plurality of processing instructions including instructions to:
instantiate focus control transfer to interface elements of return contents associated with an application upon selection of the application to focus control of a user interface;
retrieve the return contents associated with the application from a pre-load return content cache upon determination of the selection of the application;
determine focus control transfer priority rankings for the retrieved return contents based on return-contents focus-control-transfer prioritization criteria; and
transfer focus control of the user interface substantially instantly to one or more of the interface elements of the retrieved return contents according to the focus control transfer priority rankings.

17. The system of claim 16, wherein the selection of the application to focus control of the user interface takes place after the application cedes focus control of the user interface at a previous session of the application.

18. A processor-readable non-transitory medium storing processor-issuable instructions to:
instantiate focus control transfer to interface elements of return contents associated with an application upon selection of the application to focus control of a user interface;
retrieve the return contents associated with the application from a pre-load return content cache upon determination of the selection of the application, the pre-load return content cache cached prior to the retrieval;
transfer focus control to one or more of the interface elements of the return contents substantially satisfying focus control transfer criteria associated with each of the retrieved return contents.

19. The medium of claim 18, wherein the transferring of focus control is performed substantially instantly upon the selection of the application to focus control of the user interface.

20. The medium of claim 18, wherein the selection of the application to focus control of the user interface takes place after the application cedes focus control of the user interface at a previous session of the application.
